(19) United States
(12) Patent Application Publication
(10) Pub. No.: US 2009/0064882 A1
(43) Pub. Date: Mar. 12, 2009

(54) APPARATUS AND METHOD FOR FORMING CROSS FOLDS IN A WEB-FED PRINTING PRESS

(75) Inventors: Jens Elschner, Plauen (DE); Karsten Stansch, Plauen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/048,152

(22) Filed: Mar. 13, 2008

(30) Foreign Application Priority Data
Mar. 14, 2007 (DE) 10 2007 012 945.0

(51) Int. Cl. B41F 13/56

(52) U.S. Cl. 101/227

(57) ABSTRACT

An apparatus and method for forming cross folds in a web-fed printing press is disclosed. A folding unit has a longitudinal folding device and a cross folding device, which is arranged downstream from the longitudinal folding device, as seen in the transport direction of the printing substrate. The longitudinal folding device has one single former, where printing substrate webs entering the former as a strand are cut by a longitudinal cutting device assigned to the former or by at least one longitudinal cutting device assigned respectively to at least one printing substrate web of the strand by longitudinal cutting into partial webs, which exit the former as a strand, wherein the strand exiting the former can be divided downstream from the former and upstream from the cross folding device into at least three partial strands, and where a stitcher is assigned to at least one of the partial strands.

This application claims the priority of German Patent Document No. 10 2007 012 945.0, filed Mar. 14, 2007, the disclosure of which is expressly incorporated by reference herein.

### BACKGROUND AND SUMMARY OF THE INVENTION

The invention relates to an apparatus and method for forming cross folds in a web-fed printing press.

German Patent Document DE 102 59 655 B3 discloses a strand mixing device of a printing press, which is positioned between a longitudinal folding device and a cross folding device of a folding unit of the printing press. The longitudinal folding device of the folding unit disclosed therein is comprised of two formers, wherein in the area of each former printing substrate webs entering the respective former as a strand are cut into partial webs by a longitudinal cutting device assigned to the respective former. A strand of partial webs exits each former, wherein according to DE 102 59 655 B3, a strand of partial webs, which exits one of the two formers, is divided into two partial strands of partial webs. A first of these two partial strands is guided over a stitcher, and the other of the two partial strands is merged with the strand of partial webs exiting the other former, without these partial webs reaching the area of a stitcher. The folding unit in DE 102 59 655 B3 accordingly requires two formers in the area of the longitudinal folding device, wherein a strand of partial webs, which exits one of the two formers, can be divided into two partial strands of partial webs. The disadvantage of this type of folding unit is limited flexibility as well as limited production possibilities. In addition, because two formers are required in the area of the longitudinal folding unit, the folding unit is involved and expensive.

Starting herefrom, the present invention is based on the objective of creating a novel folding unit of a web-fed printing press.

According to the invention, the longitudinal folding device has one single former, wherein printing substrate webs entering the former as a strand are cut by a longitudinal cutting device assigned to the former or by at least one longitudinal cutting device assigned respectively to at least one printing substrate web of the strand by longitudinal cutting into partial webs, which exit the former as a strand, and that the strand exiting the former can be divided downstream from the former and upstream from the cross folding device into at least three partial strands, wherein a stitcher is assigned to at least one of the partial strands.

The inventive folding unit has one single former in the longitudinal folding device. This makes it possible to reduce costs. The strand exiting the sole former can be divided into at least three partial strands, wherein a stitcher is assigned to at least one of the partial strands, preferably to several of the partial strands. This allows the flexibility and production possibilities of the folding unit to be increased.

The partial strands can be merged downstream from the, or each, stitcher and upstream from the cross folding device. A stitcher is preferably assigned to each of at least two partial strands.

Preferred developments of the invention are yielded from the following description. Without being limited hereto, exemplary embodiments of the invention are explained in greater detail on the basis of the drawings.

### BRIEF DESCRIPTION OF THE DRAWINGS

FIG. 1 illustrates an inventive folding unit of a web-fed printing press according to a first exemplary embodiment.

FIG. 2 illustrates an inventive folding unit of a web-fed printing press according to a second exemplary embodiment.

FIG. 3 illustrates an inventive folding unit of a web-fed rotary printing press according to a third exemplary embodiment.

FIG. 4 illustrates an inventive folding unit of a web-fed rotary printing press according to a fourth exemplary embodiment.

FIG. 5 illustrates an inventive folding unit of a web-fed rotary printing press according to a fifth exemplary embodiment.

FIG. 6 illustrates an inventive folding unit of a web-fed rotary printing press according to a further exemplary embodiment.

### DETAILED DESCRIPTION OF THE DRAWINGS

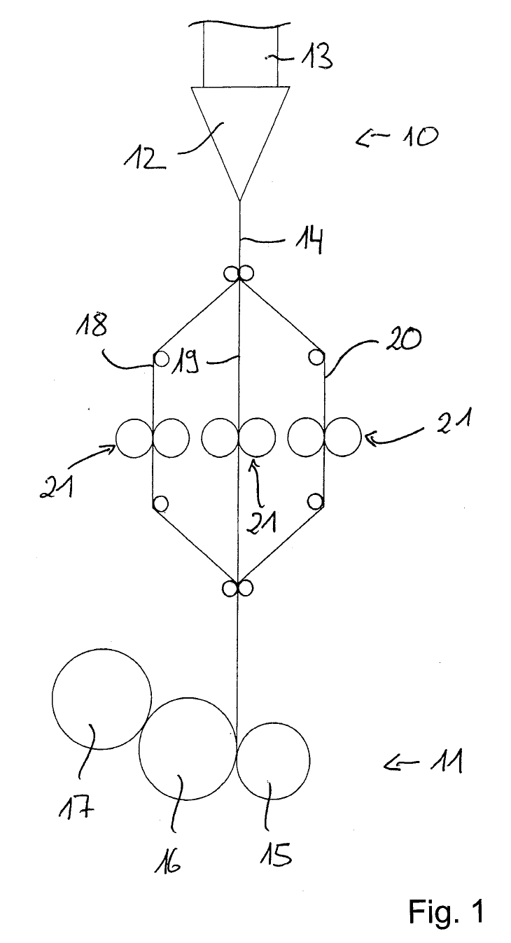

The present invention will be described in greater detail in the following making reference to FIGS. 1 through 6, wherein FIGS. 1 through 6 show schematic representations of preferred exemplary embodiments of an inventive folding unit of a web-fed rotary printing press.

The folding unit in FIG. 1 is comprised of a longitudinal folding device 10 as well as a cross folding device 11. The longitudinal folding device 10 is comprised of one single former 12, wherein a strand 13 of several printing substrate webs deposited in stack form enter the former 12. In the area of the former 12, the strand of printing substrate webs entering the former 12 are separated by longitudinal cutting into partial webs by a longitudinal cutting device (not shown) assigned to the former 12, wherein a strand 14 of partial webs exits the former 12. When a longitudinal cutting device is assigned to the former 12, as shown in FIG. 1, the longitudinal cutting of all printing substrate webs of the strand 13 takes place on the former 12. In this case, when the strand 13 entering the former 12 is comprised of a number “m” of printing substrate webs, the strand 14 exiting the former 12 is comprised of a number 2×m partial webs.

Alternatively, it is also possible that, upstream from the former 12, a longitudinal cutting device is assigned to at least one printing substrate web of the strand 13. In this case, the printing substrate webs of the strand 13 can be separated individually by longitudinal cutting, wherein it can be provided that only some of the printing substrate webs are separated into partial webs by longitudinal cutting.

The partial webs exiting the former 12 of the longitudinal folding device 10 are guided to the cross folding device 11, wherein, in the area of the cross folding device 11, copies can be separated from the partial webs by cross cutting and cross folds can be made in these copies. Thus, according to FIG. 1, the cross folding device 11 includes a cutting blade cylinder 15 in order to separate copies from the partial webs by cross cutting. In addition, the cross folding device 11 includes a folding blade cylinder 16 as well as a folding jaw cylinder 17 in order to form cross folds in the copies separated by cross cutting.

In terms of the present invention, the strand 14 that exits the sole former 12 of the longitudinal folding device 10 is divided into at least three partial strands upstream from the cross folding device 11, as seen in the transport direction of the partial webs or printing substrate webs, wherein a stitcher is assigned to at least one of the partial strands.

In the exemplary embodiment in FIG. 1, the strand 14 of partial webs exiting the former 12 is divided into three partial strands 18, 19 and 20, wherein a stitcher 21 is assigned to each of the partial strands 18, 19 and 20. In the area of the stitchers 21, the respective partial strands 18, 19 and 20 are connected together by wire stitching for example. As FIG. 1 shows, the partial strands 18, 19 and 20 are merged again after passing through the stitchers 21 upstream from the cross folding device 11.

Thus, three interleaved stitched products are yielded during so-called double production. A so-called collect run yields up to six interleaved stitched products.

There are devices in the strand guidance of the partial strands 18, 19 and 20 so that combining or merging the partial strands 18, 19 and 20 is carried out in-register.

The number of partial webs per partial strand 18, 19 and 20 may be freely selected. As a result, it is possible, for example, for each of the partial strands 18, 19 and 20 to have the same number of partial webs. It is also possible for the partial strands 18, 19 and 20 to differ in terms of the number of partial webs.

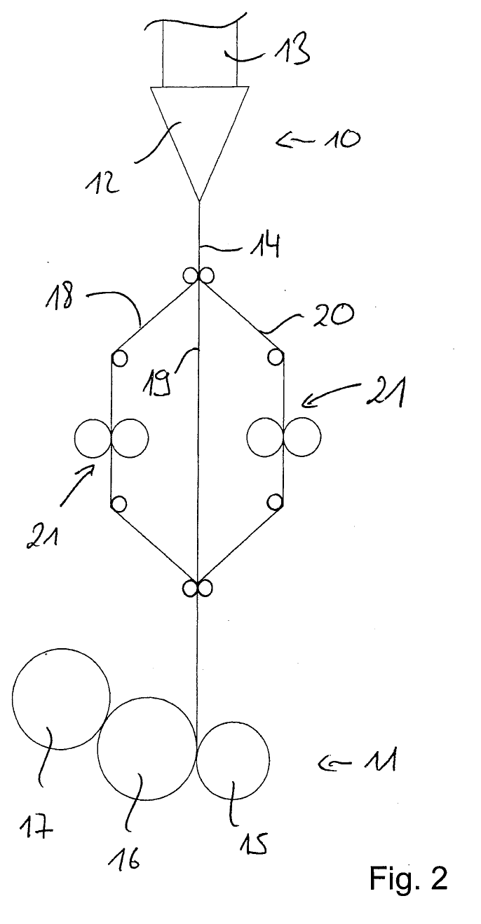

The exemplary embodiment in FIG. 2 differs from the exemplary embodiment of FIG. 1 in that a stitcher 21 is not assigned to each of the partial strands 18, 19 and 20, but only to the two outer partial strands 18 and 20 of the three partial strands.

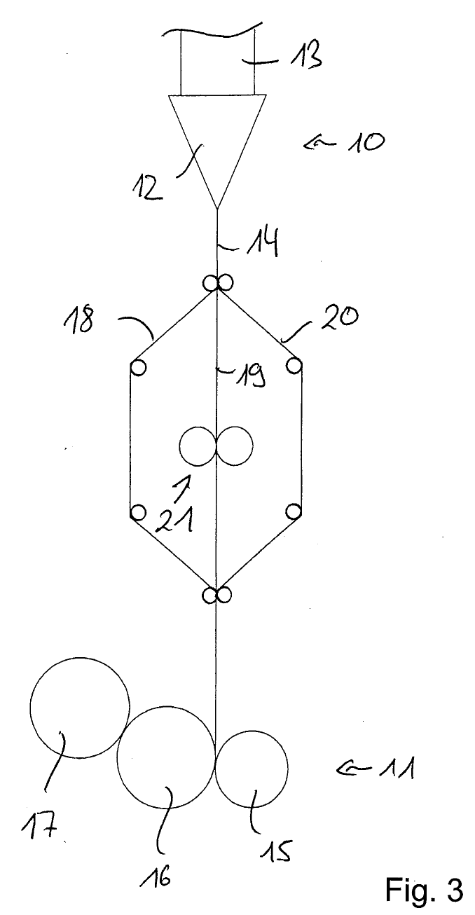

As already mentioned it is possible for the printing substrate webs of the strand 13 to be separated individually by longitudinal cutting. Thus, in connection with the exemplary embodiment in FIG. 2 for example, it can be provided that only the outer partial strands 18, 20 running over the stitchers 21 include partial webs in tabloid format created by longitudinal cutting, while, on the other hand, the center partial strand 18 includes unseparated printing substrate webs in broadsheet format. Incidentally, it is also possible, in the case of the exemplary embodiments in FIG. 3 through 6, for a partial strand or even several partial strands to include unseparated printing substrate webs in broadsheet format.

In the exemplary embodiment in FIG. 3, a stitcher 21 is assigned only to the center partial strand 19 of the three partial strands.

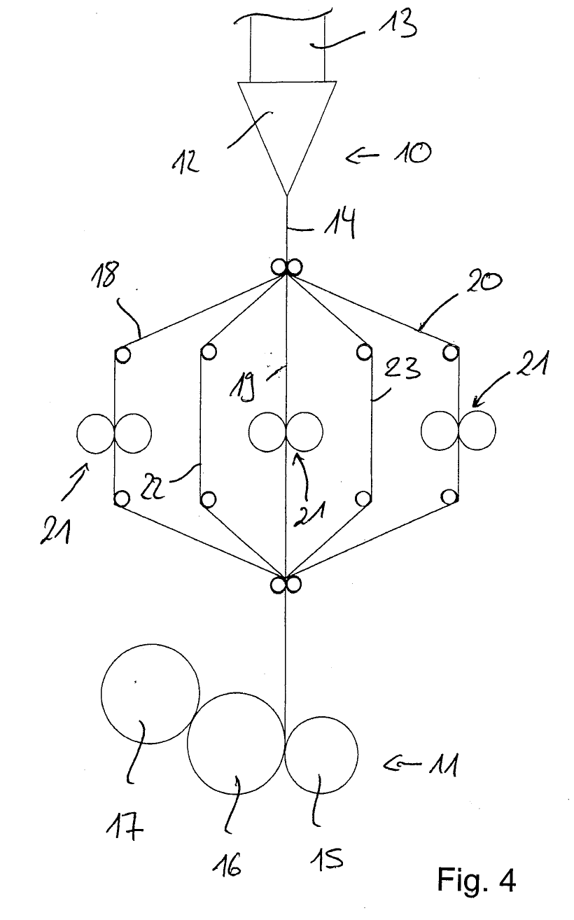

In the exemplary embodiments in FIGS. 1 through 3, the strand 14 exiting the sole former 12 can be divided into three partial strands 18, 19 and 20 of partial webs. FIGS. 4, 5 and 6, on the other hand, show exemplary embodiments, in which the strand 14 exiting the sole former 12 of the longitudinal folding device 10 can be divided into five partial strands 18, 19, 20, 22 and 23.

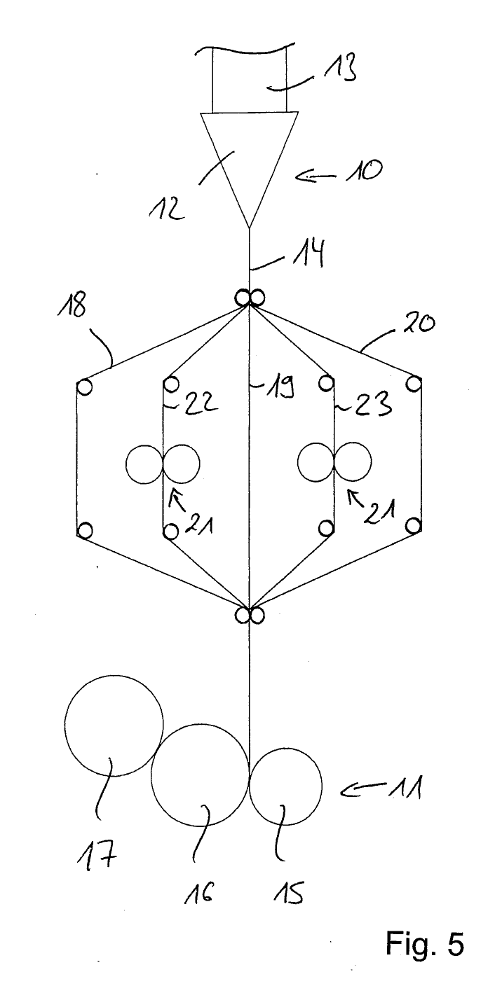

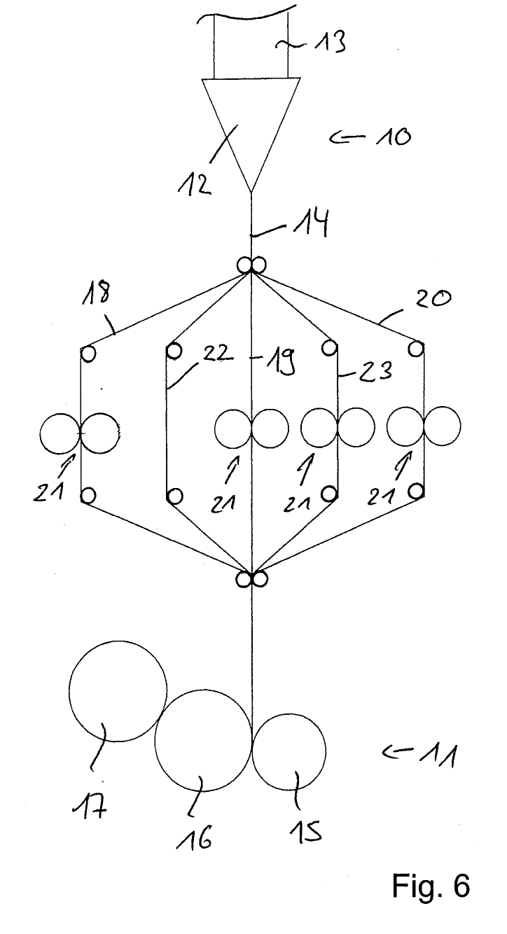

In the exemplary embodiment in FIG. 4, a stitcher 21 is assigned in this case to each of the outer partial strands 18 and 20 as well as to the center partial strand 19. In the exemplary embodiment in FIG. 5, on the other hand, a stitcher 21 is assigned to each of the two partial strands 22 and 23, each of which runs between the center partial strand 19 and an outer partial strand 18 or 20. In the exemplary embodiment in FIG. 6, a stitcher 21 is assigned to the center partial strand 19, to both outer partial strands 18, 20 as well as to the partial strand 23 running between the partial strands 19, 20.

At this point reference is made to the fact that dividing the strand exiting the former into three or five partial strands is purely of an exemplary nature. There could also be four or more than five partial strands. In terms of the present invention, the strand exiting the sole former is divided into at least three partial strands. A stitcher is assigned to at least one of these partial strands, preferably to at least two partial strands.

### LIST OF REFERENCE NUMERALS

10 Longitudinal folding device
11 Cross folding device
12 Former
13 Strand
14 Strand
15 Cutting blade cylinder
16 Folding blade cylinder
17 Folding jaw cylinder
18 Partial strand
19 Partial strand
20 Partial strand
21 Stitcher
22 Partial strand
23 Partial strand

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folding unit of a web-fed printing press having a longitudinal folding device and a cross folding device, which is arranged downstream from the longitudinal folding device, as seen in a transport direction of a printing substrate, wherein the longitudinal folding device has one single former, wherein printing substrate webs entering the former as a first strand are cut by a longitudinal cutting device assigned to the former or by at least one longitudinal cutting device assigned respectively to at least one printing substrate web of the first strand by longitudinal cutting into partial webs, wherein the first strand exits the former as a second strand, and wherein the second strand exiting the former is dividable downstream from the former and upstream from the cross folding device into at least three partial strands, wherein a stitcher is assigned to at least one of the partial strands.

2. The folding unit according to claim 1, wherein the partial strands are mergeable downstream from the stitcher and upstream from the cross folding device.

3. The folding unit according to claim 1, wherein a stitcher is assigned to each of at least two partial strands.

4. The folding unit according to claim 1, wherein the second strand exiting the former is dividable into three partial strands and wherein a separate stitcher is assigned to each of the three partial strands.

5. The folding unit according to claim 1, wherein the second strand exiting the former is dividable into three partial strands and wherein exclusively two partial strands are each assigned a stitcher.

6. The folding unit according to claim 5, wherein the two partial strands are each an outer strand.

7. The folding unit according to claim 1, wherein the second strand exiting the former is dividable into five partial strands and wherein a separate stitcher is assigned to each of the partial strands.

8. The folding unit according to claim 1, wherein the second strand exiting the former is dividable into five partial strands and wherein exclusively a center partial strand as well as both outer partial strands are each assigned a stitcher.

9. The folding unit according to claim 1, wherein the second strand exiting the former is dividable into five partial strands and wherein exclusively two partial strands, each of which runs between a center partial strand and an outer partial strand, are each assigned a stitcher.

10. A folding unit of a web-fed printing press, comprising:
a longitudinal folding device having a single former;
a cross folding device arranged downstream from the longitudinal folding device in a transport direction of a printing substrate;
wherein printing substrate webs enter the single former as a first strand, wherein the first strand exits the single former as a second strand, and wherein the second strand is divided downstream from the single former and upstream from the cross folding device into at least three partial strands; and
a stitcher is assigned to at least one of the partial strands.

11. A method for forming cross folds in a web-fed printing press, comprising the steps of:
entering printing substrate webs as a strand into a single former of a longitudinal folding device;
dividing the strand exiting from the single former into at least three partial strands;
stitching at least one of the three partial strands by a stitcher;
merging the three partial strands after the stitching step; and
cross folding the merged three partial strands.

12. The method according to claim 11, wherein the at least one of the three partial strands includes partial webs and a remaining number of partial strands of the at least three partial strands do not include partial webs.
